(19) United States
(12) Patent Application Publication
(10) Pub. No.: US 2017/0017040 A1
(43) Pub. Date: Jan. 19, 2017

(54) COLLIMATING LENS

(71) Applicant: AKTIEBOLAGET MICROPOL FIBEROPTIC, Aled (SE)

(72) Inventor: Mikael ANDERSSON, Halmstad (SE)

(21) Appl. No.: 15/123,754

(22) PCT Filed: Feb. 13, 2015
(86) PCT No.: PCT/SE2015/050177

§ 371 Date: Sep. 6, 2016

(30) Foreign Application Priority Data
Mar. 6, 2014 (SE) 1450257-9

(51) Int. Cl. G02B 6/32; G02B 3/06

(52) U.S. Cl. CPC G02B 6/32; G02B 3/06

(57) ABSTRACT

A collimating rod lens for fiber optic communication with a cylindrical envelope surface, and a spherical convex front surface, wherein the lens has a particular length L and a particular radius R of the curvature of the lens, and the spherical convex front surface is given by R=A*L+B, wherein A is a first optical glass parameter from 0.3 to 0.6; B is a second optical glass parameter from −0.1 to +0.1; the length L is from 2 to 8 mm; and the radius R of the curvature is from 0.5 to 3.5 mm.

### TECHNICAL FIELD

The present disclosure relates to a collimating lens, and more particularly to a collimating rod lens for fiber optic communication with a cylindrical envelope surface, a flat rear surface and a spherical convex front surface. The disclosure also relates to an optical fiber connector, comprising one or more collimating rod lenses.

### BACKGROUND

An optical fiber is a flexible, transparent fiber made of high quality extruded glass (silica) or plastic. The optical fiber forms a waveguide that transmits light between the two ends of the fiber.

Optical fibers are widely used in fiber-optic communications for transmission at high bandwidths and thereby providing high data rates. Optical fibers can be used as a medium for telecommunication and computer networking and can be bundled to be the center part of optical cables. Due to very low attenuation of propagating light, optical fibers are especially advantageous for long-distance communications. Optical fibers can also be advantageous for short distance communications because of its internal high bandwidth as well as to save space in cable ducts of for example office building networks.

Optical fibers forms a waveguide between a light source such as a diode and a light detector. Fiber optical connectors enable connection and disconnection between optical fibers and transmission equipment with integrated light sources and detectors but also between optical cables. The connectors mechanically couple and align the core of a fiber so light can pass through the connector. The common purpose of the optical expanded beam connectors is to expand and collimate the output light beam from a first fiber and focus the collimated beam into a receiving second fiber. Prior art arrangements have been focused on aligning an optical focus point on the surface of the optical fiber to be connected. All the existing methods to realize an expanded beam connector today are resulting in a relative high attenuation in the optical path between the fibers. Optical fibers transmit pulses of light with high bandwidth, so the terminations/connectors must be precise, but also introduce very low back reflections. The optical fiber connectors must align microscopic glass fibers perfectly in order to allow for communication. Thus, it is important especially to avoid angular deviations between the fibers. Misalignment of the fibers and reflections may cause losses of light in the connectors.

Different connectors and methods for providing a correct connection of optical fibers with each other and with other optical elements have been suggested to reduce losses. State of the art expanded beam connectors strive to optimize the focus of the light to be aligning on the surface of the connected optical fiber.

EP0892294 discloses a device for optical connection of an optical fiber with another optical element, for example a spherical lens. The device comprises a substantially sleeve-shaped retainer and a connector element. The optical fiber is fixed in the retainer, and the retainer has an end surface at which the end surface of the optical fiber is intended to be positioned. The connector element has a conical engagement surface intended to engage the end surface of the retainer. The fiber retainer and the spherical lens are maintained in firm engagement with the conical engagement surface and an edge surface formed with a radius, respectively. The conical engagement surface and the edge surface formed with a radius are positioned in relation to each other so that the optical fiber and the spherical lens are positioned on the same optical axis and at such an axial distance from each other that the end surface of the optical fiber is in the focus of the spherical lens. In such connections in which there is a space between the fiber and lens some of the light is reflected back through the optical element towards the light source. Moreover, the dimensions of optical fiber connectors and the maximum fiber packing density in systems for several optical fibers are limited by the shape of the lenses.

Reflection levels can be reduced by providing anti-reflection treatment of surfaces of the fibers and lenses. EP1376173 discloses a method for optically connecting an optical element, for example an end portion of an optical fiber, with a spherical lens, in which the optical element and the lens are fixed in a connector element in a predetermined position in relation to each other. The surface of the spherical lens facing the optical element is treated with an anti-reflection agent, for example magnesium fluoride. The anti-reflection agent, for example the magnesium fluoride, is applied to the surface of the lens facing the optical element in the form of a layer. The layer has a thickness which is in such a way adapted to the refraction index of the glass of the optical element, the refraction index of the glass of the spherical lens and the wave length of the light, which is sent through the system, that the light transmission in the connection is as high as possible and the refraction in the connection is as low as possible. Dirt particles can by introduced by the anti-reflection agent into the optical axis, thereby causing decreased transmission.

Moreover, the lens and fiber can be positioned in engagement with each other and thereby eliminating the air space to reduce reflections in the connector. This method requires a glass in the spherical lens that provides the focus to be positioned in the surface of the lens. However, dirt in between the fiber and the spherical lens can reduce the transmission area. In that case, the fiber has to be polished, wherein a small space will arise between the fiber and the spherical lens causing reflections.

SE469762 discloses a connecting device for axial connection of the end portions of at least one optical fiber with another, which are fixed in at least one plug each provided in a coupling house, in order to provide an optical connection between the fibers via a lens connectable to each fiber end. The lens is constituted by a lens body, the front end surface of which is partially spherical and the opposite, rear end surface of which is arranged perpendicular against the longitudinal axis of the lens body, that in the coupling house a ring shaped, partially spherical or conical seat is provided for the front end surface of the lens body, which seat is concentric with the longitudinal axis of the coupling house, that the plug is insertable in a coaxial guide sleeve guided in the coupling house, and that the front end of the plug can be pressed to bearing against the rear end surface of the lens body so that the partial spherical end surface of the lens body front, is pressed to bearing against the seat achieving a centering of the lens, the plug and the coupling house relatively each other.

U.S. Pat. No. 6,438,290 discloses an apparatus for coupling light from one optical fiber into another including a pair of molded plano-convex lenses. Each lens has an aspheric surface and a flat surface. The aspheric surfaces have a conic constant between −0.6 and −0.3, where the conic constant is chosen so as to give optimal coupling efficiency from a collimated beam input on the aspheric surface into an optical fiber located near the flat surface. The pair of lenses are separated by a distance approximately equal to the sum of the focal lengths of the lenses. Light from an optical fiber placed near the focal plane of one of the pair of lenses is focused into an optical fiber placed near the focal plane of the other of the pair of lenses. The overall length of the lens is chosen to be such that the optical fiber is near but with a working distance to the flat surface of the lens, which causes reflections and thereby losses of light in the connectors.

Hence, prior art connectors require that the optical fibers and the lenses are positioned on the same optical axis as well as that the end surfaces of the fibers are positioned in the focus of the lens with small tolerances.

### SUMMARY

It is an object of some embodiments to obviate at least some of the above disadvantages and to provide an improved lens for optical fiber connectors.

According to a first aspect, this is achieved by a collimating rod lens for fiber optic communication with a cylindrical envelope surface, a flat rear surface and a spherical convex front surface, wherein the lens has a particular length L and a particular radius R of the curvature of the lens, and the spherical convex front surface is given by R=A*L+B, wherein A is a first optical glass parameter from 0.3 to 0.6; B is a second optical glass parameter from −0.1 to +0.1; the length L is from 2 to 8 mm; and the radius R of the curvature is from 0.5 to 3.5 mm.

An advantage of some embodiments of the collimating lens according to the first aspect is that higher, i.e loser, tolerances are acceptable in a connection between the collimating lens and an optical fiber to be positioned in the focus of the lens. Loser tolerances reduce the requirement on the tolerances of lining devices for lining up an optical fiber with the lens. Hence, the collimating lens may be slightly tilted in the connection between the lens and the optical fiber without detrimental effect on the required optical quality in the connection. The optical attenuation of the connector is one parameter having an influencing on the quality. Less requirements on tolerances result in a cheaper machining process with less expensive machines. Another advantage is that the lens provides low attenuation and low back reflections. Still another advantage of some embodiments of the collimating lens is high quality of the optical properties in combination with the realization of a lens with small physical size.

In some embodiments, the lens is made of an optical glass with the parameters A and B optimized so that the optical attenuation between the optical fiber to be connected and the lens is minimized for a specific length L of the lens and the glass material of the lens.

In some embodiments, the optical glass has a refractive index, nd, from 1.4 to 2.1, at the wavelength 587.6 nm.

In some embodiments, the optical glass has a refractive index, nd, from 1.7 to 1.9, at the wavelength 587.6 nm.

In some embodiments, the optical glass has an Abbe number Vd≦80, which is defined as (nD−1)/(nF−nC), wherein nD, nF and nC are the refractive indexes at the Fraunhofer D, F and C spectral lines 589.3 nm, 486.1 nm and 656.3 nm.

In some embodiments, the optical glass has an Abbe number Vd≦40, which is defined as (nD−1)/(nF−nC), wherein nD, nF and nC are the refractive indexes at the Fraunhofer D, F and C spectral lines 589.3 nm, 486.1 nm and 656.3 nm.

In some embodiments, the optical glass may have any combination of refractive index and Abbe number, wherein the refractive index, nd is from 1.4 to 2.1, but preferably from 1.7 to 1.9 at wavelength 587.6 nm, and the Abbe number Vd≦80, but preferably Vd<40, wherein the Abbe number, Vd, may be defined as (nD−1)/(nF−nC), wherein nD, nF and nC are the refractive indexes at the Fraunhofer D, F and C spectral lines 589.3 nm, 486.1 nm and 656.3 nm.

In some embodiments, the lens may have a flat rear surface.

According to a second aspect an optical fiber connector is provided, comprising one or more of the collimating rod lenses according to the first aspect.

An advantage of the optical fiber connector is that very low back reflections or return loss (RL) are introduced.

Another advantage of the optical fiber connector is that it can contain a number of collimating rod lenses within a reduced space.

### BRIEF DESCRIPTION OF THE DRAWINGS

Further objects, features and advantages will appear from the following detailed description of embodiments, with reference being made to the accompanying drawings, in which:

FIG. 1 is a side view of a collimating lens according to some embodiments;

FIG. 2 is a graph illustrating the radius as a function of the length of the collimating lens;

FIG. 3 shows two collimating lenses as in FIG. 1 being used to couple light from a source fiber into a receiving fiber.

FIG. 4 shows a front view of an optical fiber connector according to some embodiments; and

FIG. 5 shows a section view along the line V-V of the optical fiber connector in FIG. 4.

### DETAILED DESCRIPTION

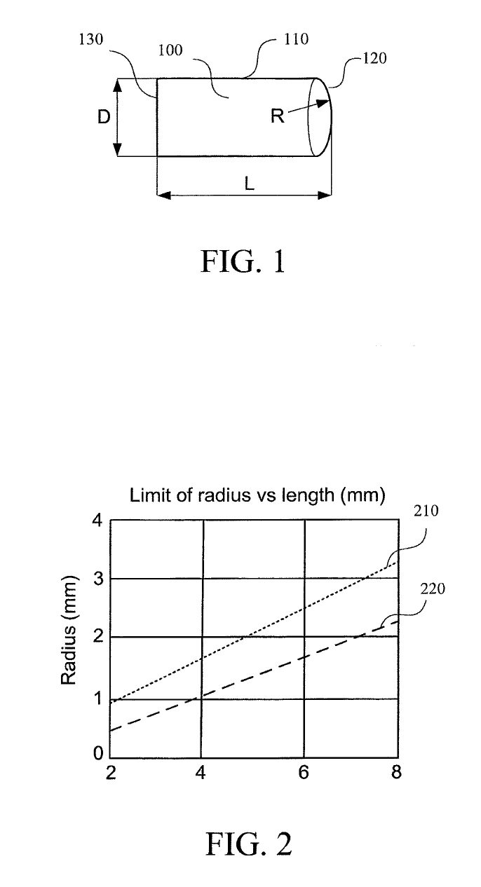

Embodiments of the invention will be described with reference to FIGS. 1-5, which illustrate schematically an example arrangement according to some embodiments.

FIG. 1 shows a collimating lens 100 for fiber optic communication. The lens 100 may be made of an optical glass rod having a cylindrical shape defined by a certain diameter D, length L and radius R of the curvature of the lens. In some embodiments, the lens 100 has a cylindrical envelope surface 110. a spherical or near spherical convex front surface 120 with the radius R and a flat rear surface 130 forming a collimating rod lens. However, the collimating rod lens is not limited to these particular shapes of the surfaces. The lens should be shaped in a way to minimize the attenuation between two optical fibers, when two lenses are arranged to expand and collimate the optical patch between the fibers. Thus, the front surface 120 and rear surface 130 may have other shapes, for expanding and collimating a light beam from a source fiber or focus a collimated beam into a receiving fiber.

The optical glass may have, but is not limited to a combination of refractive index and Abbe number wherein the refractive index or index of refraction (at wavelength 587.6 nm) nd: 1.4≦nd≦2.1, but preferably from 1.7-1.9 and an Abbe number Vd≦80, but preferably Vd<40. The refractive index is defined in normal room temperature and atmospherically conditions and at wavelength of 587.6 nm.

The abbe number Vd is defined as (nD−1)/(nF−nC), wherein nD, nF and nC are the refractive indexes at the Fraunhofer D, F and C spectral lines 589.3 nm, 486.1 nm and 656.3 nm.

FIG. 2 shows a graph illustrating the radius R in mm as a function of the length in mm of the lens as described in connection with FIG. 1. The shape of the rear surface 130 of the lens may be flat or any other shape and the front surface 120 of the lens is given by: R=f(L), wherein f(L) is a function of L as a variable describing the shape of the lens to be spherical. A functional shape of the rod lens 100 with a spherical or near spherical front surface is defined by the expression:

R=A*L+B

wherein A and B are optical glass parameters defining the type of optical glass of the lens. The optical glass of the lens may for example be made of different types of glass material.

With reference to FIG. 2, the collimating rod lens 100 may have a radius R from 0.5 to 3.5 mm and a length L from 2 to 8 mm. The parameter A may have a value from 0.3 to 0.6 and the parameter B may have a value from −0.1 to +0.1, depending on the type of optical glass. These values may be put into the formula R=A*L+B, thereby defining a certain relation between the radius, length and shape of the lens that may vary between values illustrated by a dotted line 210 and a dashed line 220 as shown in FIG. 2. The diameter D of the lens may be but is not limited to 1 to 4 mm.

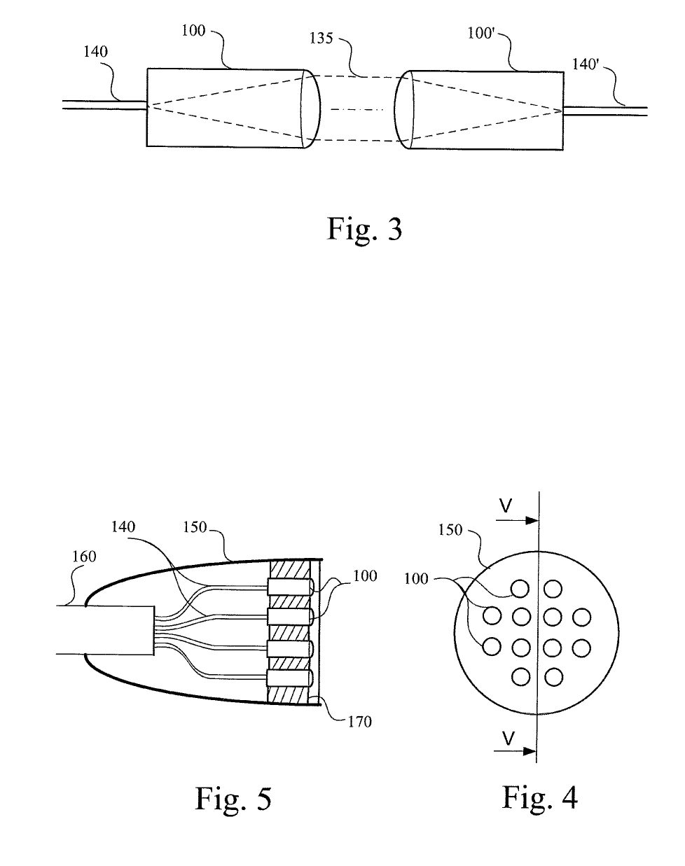

FIG. 3 shows two collimating rod lenses 100 and 100′ as described above being used to couple light 135 from a source fiber 140 into a receiving fiber 140′. The optical fibers may be of either single mode or multimode. The lenses 100. 100′ may be connected or attached to and against their respective optical fiber 140 and 140′ by means of for example an adhesive or fixed, or biased with or without and adhesive. The adhesive may be an UV curable adhesive or an optical index-matching adhesive. The respective lens may preferably be connected without a gap against the optical fiber. Minor angular deviations between the fibers and the lenses may be allowable without generating reflections causing unacceptable losses of light in the connectors.

FIG. 4 shows a front view of an optical fiber connector 150 according to some embodiments for a number of optical fibers connected to a corresponding number of lenses 100.

FIG. 5 shows a section view along the line V-V of the optical fiber connector 150 in FIG. 4. The optical fibers 140 are arranged in a bundle or cable 160 connected to the corresponding number of collimating rod lenses 100 as described above. The lenses 100 are arranged in a holder or socket 170. Due to the rod shape of the lens a number of lenses can be arranged in different configurations in the holder. In this embodiment the holder is adapted for 12 lenses. However, fewer or more, for example 6, 7, 8, 10, 14, 16 or 20 lenses may be arranged in various configurations in a connector according to other embodiments.

According to some embodiments, the optical fiber lenses and optical fiber connectors enable connection and disconnection between optical fibers and are used to connect equipment and cables, between an optical fiber and a light source, i.e a diode, between an optical fiber and a light detector etc. The connectors mechanically couple and align the cores of fibers so light can pass. The optical fiber connectors expand and collimate the output light beam from a first fiber and focus the collimated beam into a receiving second fiber. The focusing is achieved by optimizing the parameters A and B in such a way that the optical attenuation between the optical fiber to be connected to the optical fiber lens is minimized for a specific length L of the lens and the glass material of the lens. The wavelength of the light may be, but is not limited to, 1310-1550 nm. The collimating rod lenses and optical fiber connectors may be used in different optical fiber applications and appliances for telecommunication, computer networking, sensors in medical devices, mining, the military, television etc.

The features and advantages of the invention are apparent from the detailed specification, and thus, it is intended by the appended claims to cover all such features and advantages of the invention, which fall within the scope of the technology. For example, the lens may be made of any type of optical glass However, although embodiments of the technology have been illustrated in the accompanying drawings and described in the foregoing detailed description, the disclosure is illustrative only and changes, modifications and substitutions may be made without departing from the scope of the technology as set forth and defined by the following claims. For example, in some embodiments the optical glass may have any combination of index of refraction and Abbe number, within the ranges described herein. Hence, it should be understood that the limitations of the described embodiments are merely for illustrative purpose and by no means limiting. Instead, the scope of the technology is defined by the appended claims rather than by the description, and all variations that fall within the range of the claims are intended to be embraced therein.

1. A collimating rod lens of an optical glass for fiber optic communication with a cylindrical envelope surface, and a spherical convex front surface, wherein the lens has a length L and a radius R of the curvature of the front surface of the lens, related to each other by the expression R=A*L+B, wherein A ranges from 0.3 to 0.6; B ranges from −0.1 to +0.1; the length L is from 2 to 8 mm; and the radius R of the curvature is from 0.5 to 3.5 mm, wherein the optical glass has a refractive index in the range from 1.7 to 1.9.

2. The collimating rod lens of claim 1, wherein the lens is made of an optical glass with the parameters A and B optimized so that the optical attenuation between the optical fiber to be connected and the lens is minimized for a specific length L of the lens and the glass material of the lens.

3. The collimating rod lens of claim 2, wherein the optical glass has a refractive index, nd, from 1.4 to 2.1 at the wavelength 587.6 nm.

4. The collimating rod lens of claim 2, wherein the optical glass has a refractive index, nd, from 1.7 to 1.9 at the wavelength 587.6 nm.

5. The collimating rod lens of claim 2, wherein the optical glass has an Abbe number Vd≦80, which is defined as (nD−1)/(nF−nC), wherein nD, nF and nC are the refractive indexes at the Fraunhofer D, F and C spectral lines 589.3 nm, 486.1 nm and 656.3 nm.

6. The collimating rod lens of claim 2, wherein the optical glass has an Abbe number Vd≦40, which is defined as (nD−1)/(nF−nC), wherein nD, nF and nC are the refractive indexes at the Fraunhofer D, F and C spectral lines 589.3 nm, 486.1 nm and 656.3 nm.

7. The collimating rod lens of claims 2, wherein the optical glass has any combination of refractive index and Abbe number, wherein the refractive index, nd, is from 1.4 to 2.1, at the wavelength 587.6 nm and the Abbe number Vd≦80, wherein the Abbe number, Vd, is defined as (nD−1)/(nF−nC), wherein nD, nF and nC are the refractive indexes at the Fraunhofer D, F and C spectral lines 589.3 nm, 486.1 nm and 656.3 nm.

8. The collimating rod lens of claim 1, wherein the lens has a flat rear surface

9. An optical fiber connector, comprising one or more collimating rod lenses according to claim 1.

10. The collimating rod lens of claim 7, wherein the refractive index, nd, is from 1.7 to 1.9, at the wavelength 587.6 nm.

11. The collimating rod lens of claim 7, wherein the Abbe number is Vd<40.
